(19) United States
(12) Patent Application Publication
(10) Pub. No.: US 2021/0046580 A1
(43) Pub. Date: Feb. 18, 2021

(54) SYSTEM FOR PERFORMING OPERATIONS FOR MAKING A WORKPIECE STARTING WITH A CAST

(71) Applicant: MECCANICA PI.ERRE S.R.L. DI PEDERZOLI RUGGERO & C., Bedizzole (Brescia) (IT)

(72) Inventor: Ruggero PEDERZOLI, Bedizzole (Brescia) (IT)

(21) Appl. No.: 16/980,460

(22) PCT Filed: Mar. 15, 2019
(86) PCT No.: PCT/IB2019/052129

§ 371 Date: Sep. 14, 2020

(30) Foreign Application Priority Data
Mar. 20, 2018 (IT) 102018000003770

(51) Int. Cl. B23K 26/00; B23K 26/03; B23K 26/08; B23K 26/361; B23K 26/38; B23K 31/12; B23K 37/047

(52) U.S. Cl. CPC B23K 26/0093; B23K 26/03; B23K 26/0876; B23K 2101/006; B23K 26/38; B23K 31/125; B23K 37/047; B23K 26/361

(57) ABSTRACT

A system performing operations for making a workpiece starting with a cast is provided. The system includes a loading station into which a cast obtained from foundry operations is loaded, an unloading station in which the workpiece is unloaded, and an operating station carrying out cutting operations on parts to be discarded from the cast, including operations for eliminating sprues, cast runners, wells, vacuum branches, and foundry burrs. The operating station has a laser head that emits through a delivery source a laser beam that cuts predefined portions of the cast and head support and movement means operatively connected to the laser head to support and move it according to a predefined cutting path along which to cut from the cast parts to be discarded.

The present invention concerns a system that performs operations for making a workpiece starting with a cast. At the same time, the object of the present invention is also a process for making a workpiece starting with a cast.

In particular, according to the present treatment, the “cast” is the product obtained through foundry operations. Specifically, “cast” means a product that is obtained by gravity cast operations, at low pressure, or in die-casting. The cast, therefore, comprises a number of portions, necessary for the optimal success of the foundry operations, that are subsequently to be eliminated: sprues, cast runners, wells, vacuum branches, foundry burrs and/or the like.

Thus, starting from the cast, obtained through foundry operations, it is necessary to carry out specific operations for the elimination of said parts, in order to obtain a semi-finished workpiece.

Preferably, the present invention is placed in a technical context wherein said cast and the resulting workpiece are made of metallic material, for example, of ferrous alloy or of non-ferrous alloy, for example, a light alloy, such as an aluminum alloy, a brass alloy or a magnesium alloy.

In the state of the art there are known systems and machinery that perform mechanical operations on the cast, and particularly cutting operations, which involve the separation of such portions, thus obtaining a semi-processed or semi-finished piece on which to perform further mechanical operations to finish it and make it ready for market.

The main problem encountered in such systems and machinery is that of not being flexible: these mechanical operations may only be carried out on casts that are substantially the same. In particular, each mechanical cutting operation is designed and intended specifically for a specific cast. In effect, for each cast, a special cutting die is designed and driven by a special machine, also known as a “cutting press”.

In addition, it should be noted that mechanical cutting operations on particularly complex casts require the execution of specific complex operations, which in some cases may require several passages, involving relatively long times.

The need is therefore strongly felt to overcome these problems related to mechanical cutting.

Therefore, the object of the present invention is to provide a system that meets this need by placing itself in this specific context of operations on foundry casts, remedying the aforesaid problems.

This object is achieved by means of the system claimed in claim 1. However, at the same time, this object is also achieved by the process carried out by such a system in accordance with claim 13, and also by the process claimed in claim 14. The claims dependent thereon show preferred embodiments involving further advantageous aspects.

The object of the present invention is hereinafter described in detail with the aid of the accompanying figures, wherein:

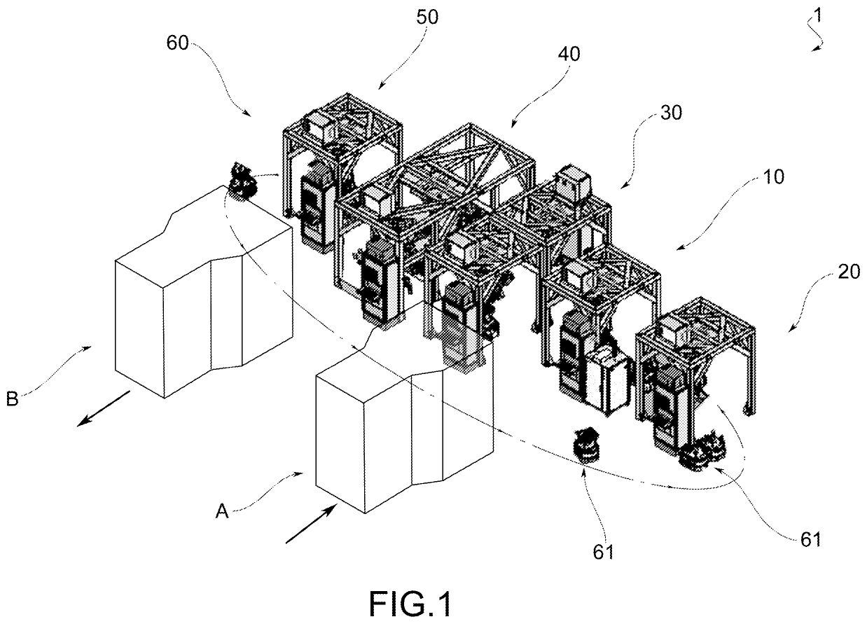

FIG. 1 shows a schematic perspective view of the system that is the object of the present invention, according to a preferred embodiment;

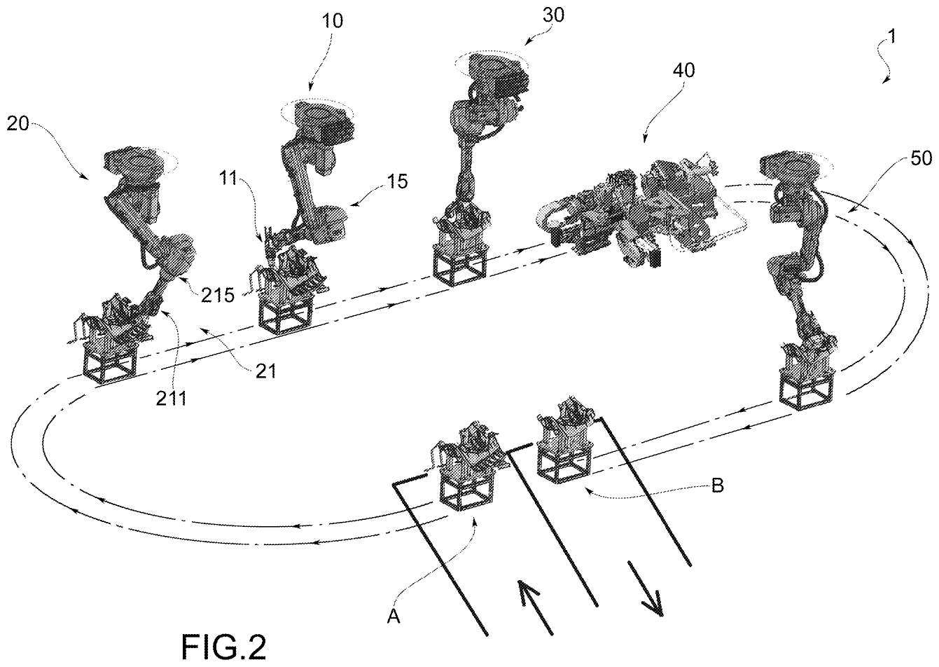

FIG. 2 shows a further schematic view of a system of machines according to the present invention;

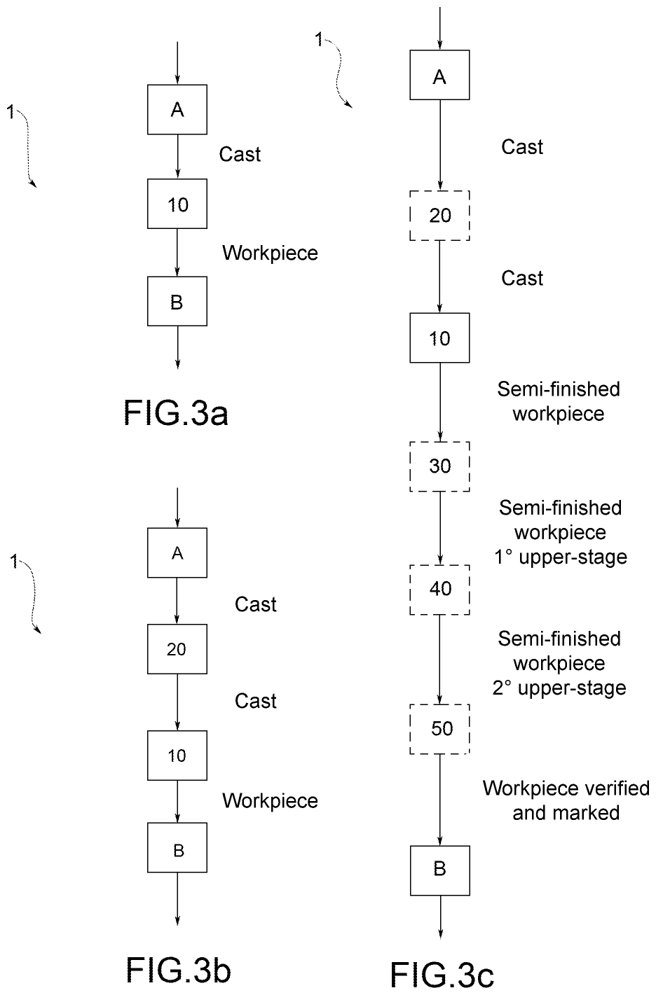

FIGS. 3a, 3b and 3c show, by means of block diagrams, three respective preferred embodiments of the system that is the object of the present invention.

With reference to the aforesaid figures, a system such as the one that is the object of the present invention, i.e. a system that performs operations for making a workpiece from a cast, is indicated at number 1.

In particular, the system 1, object of the present invention, comprises a loading station A in which is loaded a cast obtained from foundry operations and an unloading station B in which the workpiece is unloaded.

In other words, a cast, which has been obtained by means of foundry operations, enters the system 1 and a finished or semi-finished workpiece emerges to be placed on the intended market. In particular, said workpieces include components such as the block of an engine or the body of a gearbox or transmission unit, or structural components such as the suspension housing of a vehicle, or shafts or supporting structures of automotive components. In other words, said workpieces have a substantially three-dimensional aspect.

According to the present invention, between the loading station A and the unloading station B, the system 1 comprises an operating station 10 in which the operations for cutting the respective parts to be discarded from the cast are carried out, such as despruing and deburring operations.

In other words, a workpiece enters the operating station 10 and the finished and/or semi-finished product exits. In effect, all the parts to be removed are cut in the operating station 10. With particular non-limiting reference to FIG. 2, a cast is shown accommodated in the operating station, while in the subsequent station, there is a finished and/or semi-finished workpiece.

Said operating station 10 comprises a laser head 11 that emits, through a delivery source, a laser beam that cuts predefined portions of the cast.

In addition, said operating station 10 comprises head support and movement means 15 operatively connected to the laser head 11 to support the head and move it according to a predefined cutting path along which to carry out the cutting of the cast.

In other words, in the operating station 10, the cutting operations (i.e. removal) of the parts to be discarded are carried out on the incoming cast by means of the appropriately moved laser head, rather than mechanically.

Preferably, the laser head 11 is moved along a preferred cutting path. In other words, the laser head 11 is moved around the cast to separate sprues, cast runners, wells, vacuum branches, foundry burrs and/or the like therefrom. Typically, around a cast there is a multiplicity of such portions to be eliminated.

Preferably, the laser head 11 is moved by the head support and movement means 15 along a single predefined cutting path, along which it performs a single consecutive cutting operation.

Otherwise, the laser head 11 is moved by the head support and movement means 15 through a plurality of consecutive cutting operations. For example, first performing perimeter cuts and then cutting the inner portions of the workpiece.

In other words, according to the present invention, the laser head 11 is moved and operates in such a way as to avoid the need to pass over the same portion of the cast several times.

In accordance with the present invention, the cutting path is the shortest path to perform said cutting operations in a single pass over the workpiece.

In accordance with a preferred embodiment, the laser head 11 in its cutting path operates on portions to be cut of different thicknesses.

According to a preferred embodiment, the laser head emits, through the delivery source, a laser beam of variable intensity depending on the thickness of the portion of the cast to be cut.

For example, at a certain thickness, the laser head emits a laser beam with an intensity that is three times greater than the laser beam emitted at a thickness that is three times smaller. For example, the laser beam emitted for cutting a sprue is more intense than the laser beam for cutting a burr.

According to a preferred embodiment, said head support and movement means 15 are of the type comprising an anthropomorphic robot supporting the laser head 11.

According to a preferred embodiment, the system 1 further comprises a detection station 20, positioned between the loading station A and the operating station 10, i.e. upstream of the operating station 10.

Said detection station 20 comprises a detection device 21 that detects the dimensions and shapes of the cast, detecting the position of its parts to be discarded. In other words, the detection station 20 distinguishes and detects the various portions of the cast, recognizing the shapes, sizes, and relative position of the different parts.

In other words, the detection station 20 is suitable for detecting any geometric differences between casts. This means that the detection station detects the dimensional differences and the different dimensional tolerances of the cast and the parts thereof typically due to the foundry operations.

According to a preferred embodiment, the detection device 21 comprises at least one laser sight 211 preferably moved by the laser sight support and movement means 215.

According to a preferred embodiment, said laser sight support and movement means 25 are of the type comprising an anthropomorphic robot supporting the laser sight 211.

According to a preferred embodiment, the detection device 21 is also suitable to identify the thicknesses of portions of the cast.

For example, the detection device 21 is suitable to detect the apparent thickness of a sprue (i.e. typically from 3 to 6 mm), relative to the apparent thickness of a cast well (i.e. typically from 1 to 3 mm), relative to the thickness of a foundry burr (i.e. typically between 0.1 and 0.5 mm).

According to a preferred embodiment of the present invention, moreover, the system 1 comprises a processing unit that receives the information collected by the detection device 21 and processes it to define the dedicated cutting path along which the laser head 11 of the operating station 10 operates.

In other words, the processing unit translates the information collected in the detection station 20 according to the specific cast entering the system. The processing unit receives information from the detection station 20 and, by means of mathematical calculations and specific algorithms, translates it into coordinates along which the laser head 11 is controlled to cut the respective portions of the cast. In particular, therefore, the processing unit controls the trajectory and the laser intensity of the respective portions, sizes and shapes of the cast.

According to a preferred embodiment, the detection station 20 also checks whether a cast is to be discarded or not, upstream of the execution of the first operations thereon.

According to a preferred embodiment, the system 1 also comprises a deburring station 30, located downstream of operating station 10. In particular, this deburring station 30 performs deburring operations on the semi-finished product exiting the operating station 10. By means of the deburring station 30, the burrs from laser cutting are thus eliminated from the semi-finished product.

Preferably, the deburring station 30 is also suitable to perform deburring operations on residual burrs that were not removed or were only partially removed in the operating station 10.

According to a preferred embodiment, the deburring station 30 comprises a control robot that carries a tool driven to rotate by a moving motor spindle.

According to a preferred embodiment, the system 1 further comprises an auxiliary operating station 40, positioned downstream of the operating station 10, suitable to perform mechanical operations on the exiting semi-finished product, obtaining a semi-finished upper-stage workpiece.

For example, said auxiliary operating station 40 is suitable to perform mechanical operations, such as drilling, or punching, or tapping, or milling, on the semi-finished workpiece at the exit from the deburring station 30.

According to a preferred embodiment, the final semi-finished workpiece is obtained at the exit from the operating station 10. According to some variant embodiments, the final semi-finished workpiece is obtained at the exit from the deburring station 30. According to further variant embodiments, the final semi-finished workpiece is obtained at the exit from the auxiliary operating station 40.

According to a preferred embodiment, the processing unit receiving the information from the detection station 20 controls the subsequent operations to be carried out also in the deburring station 30 and in the auxiliary operating station 40.

Moreover, according to a further embodiment of the present invention, the system 1 comprises a control station 50, located upstream of the unloading station B, which performs dimensional control and mechanical quality control operations on the semi-finished workpiece in the previous stations.

In addition, preferably, said control station 50 also performs marking and tracking operations on the workpiece.

According to a preferred embodiment, the control station 50 also checks whether a semi-finished or finished workpiece is to be discarded or not, i.e. downstream of the execution of the operations described above.

According to a preferred embodiment, the control station 50 performs mechanical or laser marking operations on the workpiece. Preferably, the control station 50 comprises a robot with a laser having suitable intensity to perform the marking operations of the workpiece.

According to a preferred embodiment, the system 1 comprises cast-workpiece movement means, which move the cast-workpiece through the different stations from the loading station A to the unloading station B.

Preferably, the cast-workpiece movement means follow specific tracks. In other words, the cast-workpiece movement means move the cast-workpiece in substantially one direction.

Preferably, the cast-workpiece movement means comprise at least one robot movement unit with automated guidance 61. In other words, the cast-workpiece movement means move the cast-workpiece by moving the robot movement unit with automated guidance 61 as needed.

Preferably, therefore, the robot movement unit with automated guidance 61 may also skip some of the described stations as required.

Also object of the present invention is a process for making a workpiece starting from a cast obtained by foundry operations through a system according to any one of the preceding claims.

Moreover, object of the present invention is a generic process for making a workpiece starting with a cast obtained by foundry operations comprising the steps of:
performing the operations of cutting from the casts the respective parts to be discarded, for example operations to eliminate sprues, cast runners, wells, vacuum branches, foundry burrs and/or the like, by means of an operating station which comprises a laser cutting head.

According to a preferred embodiment, the process provides that these operations be performed by the laser cutting head as needed, for example by varying the intensity of the laser, or making multiple passes on the same portion of the cast.

According to this preferred embodiment, the process further comprises the steps of:
detecting the dimensions and shape of the cast and detecting the position of its parts to be discarded;
performing the aforesaid operations for cutting casts by means of the laser head according to the cutting path detected in the previous steps.

Preferably, therefore, the process comprises the step of processing the information detected to perform the operational step of laser cutting in the most effective and efficient way possible.

Innovatively, the system that is the object of the present invention is suitable to solve the problems of the prior art. At the same time, the process that is the object of the present invention also solves these problems.

Advantageously, the present invention is characterized by high flexibility. Advantageously, in the operating station, casts of different sizes or shapes may be cut, unlike the operating stations that comprise dies and mechanical cutting presses that are instead specifically for working on a workpiece of the predefined shape and size.

Advantageously, casts are randomly loadable in the system.

Advantageously, the system that is object of the present invention is a flexible and universal solution for the execution of cutting operations on casts: within the maximum operating radius of the head support and movement means, i.e. of the anthropomorphic robot, any type of cast may be processed.

Advantageously, a cast enters the system, and a semi-finished or finished workpiece exits, its shape and physical characteristics having been verified.

Advantageously, the laser head is suitable to operate in such a way as to take into account the dimensional variations of the cast. Advantageously, the laser head is controllable with a variable intensity depending on the types of portions to be cut.

Advantageously, the cutting path is calculated to be as fast as possible, taking into account the different portions of the cast.

Advantageously, the radius trajectory takes into account possible dimensional variations related to production operations of the foundry.

Advantageously, the laser is extremely suitable to perform cutting operations on casts made of metal material, preferably made of a ferrous metal or a non-ferrous metal, e.g. a light alloy, e.g. an aluminum alloy, a brass alloy or a magnesium alloy.

Advantageously, the laser head is movable in six dimensions as needed to reach the most impervious and difficult to access portions of the cast. Advantageously, the laser head is movable to operate at the most effective and efficient inclination possible.

Advantageously, the system checks the cast at the entrance, evaluating the possibility of discarding it directly, thus avoiding the execution of the respective operations thereon.

Advantageously, the system checks the workpiece before it leaves, evaluating the possibility of discarding it directly, thus avoiding that the same proceeds towards the use or sale thereof.

To the embodiments of the system, one skilled in the art, in order to meet specific needs, may make variants or substitutions of elements with others that are functionally equivalent. Such variants are also contained within the scope of protection as defined by the following claims.

Moreover, each variant described as belonging to a possible embodiment may be implemented independently of the other variants described.

1. A system performing operations for making a workpiece starting with a cast, the system comprising a loading station, in which a cast obtained by foundry operations is loaded, and an unloading station, in which the workpiece is unloaded, wherein the system further comprises an operating station between the loading station and the unloading station, wherein, in the operating station, operations for cutting the cast are performed, including operations to eliminate sprues, cast runners, wells, vacuum branches, and foundry burrs, the operating station comprising:
a laser head that emits a laser beam through a delivery source that cuts predefined portions of the cast; and
head support and movement means operatively connected to the laser head to support and move the laser head according to a predefined cutting path along which to cut from the cast parts to be discarded.

2. The system of claim 1, wherein the laser head is moved by the head support and movement means along a single predefined cutting path, along which is performed a single, consecutive cutting operation or a plurality of consecutive cutting operations.

3. The system of claim 1, wherein said laser head emits, through the delivery source, a laser beam of variable intensity according to a thickness of a portion of the cast to be cut.

4. The system of claim 1, further comprising a detection station, positioned between the loading station and the operating station, wherein the detection station comprises a detection device which detects dimensions and shapes of the cast, detecting position of parts of the cast to be discarded.

5. The system of claim 4, wherein the detection device further comprises at least one laser sight preferably moved by laser sight support and movement means.

6. The system of claims 4 and 5, wherein the detection device is suitable to define also thicknesses of portions of the cast.

7. The system of claim 4, further comprising a processing unit that receives information collected by the detection device and processes it to define a dedicated cutting path along which the laser head of the operating station operates.

8. The system of claim 1, further comprising a deburring station positioned downstream of the operating station, performing deburring operations on a semi-finished workpiece exiting the operating station, to eliminate laser-cutting burrs generated in cutting operations by the operating station.

9. The system of claim 8, further comprising an auxiliary operating station, positioned downstream of the operating station and/or downstream of the deburring station, wherein said auxiliary operating station performs mechanical operations on the semi-finished workpiece exiting at least one of the operating station or the deburring station, obtaining a semi-finished, upper-stage workpiece.

10. The system of claim 1, further comprising a control station, positioned upstream of the unloading station, which performs dimensional control and mechanical quality control operations on the workpiece.

11. The system of claim 10, wherein the control station also performs marking and tracking operations on the workpiece.

12. The system of claim 1, further comprising cast-workpiece movement means, which move a cast-workpiece through different stations starting from the loading station and ending at the unloading station.

13. A process for making a workpiece starting from a cast obtained by foundry operations carried out by a system comprising a loading station, in which the cast is loaded, an unloading station, in which the workpiece is unloaded, and an operating station between the loading station and the unloading station, wherein, in the operating station, operations for cutting the cast are performed, including operations to eliminate sprues, cast runners, wells, vacuum branches, and foundry burrs, the operating station comprising a laser head that emits a laser beam through a delivery source that cuts predefined portions of the cast, and head support and movement means operatively connected to the laser head to support and move the laser head according to a predefined cutting path along which to cut from the cast parts to be discarded.

14. A process for making a workpiece starting from a cast obtained by foundry operations, the process comprising the steps of:
performing operations of cutting from the cast parts to be discarded, including operations to eliminate sprues, cast runners, wells, vacuum branches, and foundry burrs, by an operating station comprising a laser head.

15. The process of claim 14, further comprising the step of:
detecting dimensions and shapes of the cast and position of parts of the cast to be discarded; and
performing the operations of cutting, the cast by the laser head according to a predefined cutting path after the detecting step.

16. The system of claim 1, wherein the laser head avoids needing to pass over a same portion of the cast multiple times.

17. The system of claim 12, wherein said cast-workpiece movement means comprise at least one robot movement unit with automated guidance.
